(19) United States
(12) Patent Application Publication
(10) Pub. No.: US 2024/0363882 A1
(43) Pub. Date: Oct. 31, 2024

(54) ASSEMBLY GUIDE AND BATTERY MODULE MANUFACTURING METHOD

(71) Applicant: SK On Co., Ltd., Seoul (KR)

(72) Inventors: Wook Hyun KIM, Daejeon (KR); Kwan Yong KIM, Daejeon (KR); Yun U CHANG, Daejeon (KR); Yong Hun JUNG, Daejeon (KR)

(21) Appl. No.: 18/586,541

(22) Filed: Feb. 26, 2024

(30) Foreign Application Priority Data
Apr. 27, 2023 (KR) 10-2023-0055458

(51) Int. Cl. H01M 10/04; H01M 50/211; H01M 50/516

(52) U.S. Cl. CPC H01M 10/0404; H01M 50/211; H01M 50/516

(57) ABSTRACT

An assembly guide according to an embodiment of the present disclosure is used to align cell tabs to couple a bus bar assembly to the cell tabs protruding from a plurality of battery cells stacked, and the assembly guide includes: a base portion contacting the bus bar assembly as the bus bar assembly is coupled to the cell tabs; a cell tab accommodating portion including a plurality of a plurality of grooves formed at one end of the base portion to face the cell tabs; and a load cell disposed on the base portion to measure a load applied to the assembly guide.

### CROSS-REFERENCE TO RELATED PATENT APPLICATION

The present application claims priority under 35 U.S.C. § 119 (a) to Korean patent application number 10-2023-0055458 filed on Apr. 27, 2023, in the Korean Intellectual Property Office, the entire disclosure of which is incorporated by reference herein.

### BACKGROUND OF THE INVENTION

### 1. Field

Embodiments of the present disclosure relate to an assembly guide and a battery module manufacturing method.

### 2. Description of the Related Art

Recently, secondary batteries are widely used not only in small devices such as mobile electronic devices but also in medium-to-large devices such as automobiles and power storage devices. In particular, as carbon energy is gradually depleted, and interest in the environment increases, public attention is focused on hybrid vehicles and electric vehicles around the world, including the United States, Europe, Japan, and Korea.

In these hybrid vehicles and electric vehicles, the most critical component is the battery pack, which provides driving force to the vehicle motor. Since hybrid cars and electric cars may obtain the driving force of the vehicles through charging and discharging of the battery pack, they have a superior fuel efficiency and discharge no pollutants, compared to vehicles using only an engine, and thus the users are gradually increasing to a great number.

In addition, a battery pack used in a hybrid vehicle or electric vehicle includes a battery module including a plurality of battery cells, and as a plurality of battery cells are connected to each other in series and/or in parallel, the capacity and output of a battery module are increased.

Cell tabs are formed on both ends of a battery cell to allow a plurality of battery cells to be electrically connected, and these cell tabs are coupled and welded with a bus bar assembly to maintain a state of being electrically connected.

However, in the cases where the width of slots formed on an earthly strip of a bus bar assembly, through which cell tabs of battery cells pass, is very narrow, and the direction of the cell tabs is slightly distorted due to a cumulative stacking tolerance of cell tabs according to the stacking of battery cells, insertion through the slots may not be performed, and consequently, a fatal problem that a completely assembled battery pack may not function properly may occur.

Furthermore, the problem that cell tabs and battery cells are damaged may occur in the process of coupling cell tabs with a bus bar assembly.

Therefore, there is a need for a new battery module manufacturing method that can minimize damage or deformation of battery cells and cell tabs included therein and at the same time, easily perform the coupling of cell tabs and a bus bar assembly.

### SUMMARY OF THE INVENTION

Embodiments of the present disclosure provide an assembly guide and a battery module manufacturing method that can minimize damage or deformation of battery cells and cell tabs included therein and at the same time, easily perform the coupling of cell tabs and a bus bar assembly.

Battery cells included in embodiments of the present disclosure can be widely applied in the field of green technology, such as electric vehicles, battery charging stations, solar power generation, and wind power generation using batteries.

An assembly guide according to an embodiment of the present disclosure is an assembly guide used to align cell tabs to couple a bus bar assembly with the cell tabs protruding from a plurality of battery cells stacked, and the assembly guide includes: a base portion contacting the bus bar assembly as the bus bar assembly is coupled with the cell tabs; a cell tab accommodating portion including a plurality of grooves formed at one end of the base portion to face the cell tabs; and a load cell disposed on the base portion to measure a load applied to the assembly guide.

In one embodiment, the load cell may measure a load applied to the assembly guide in a height direction perpendicular to both a direction in which the cell tabs protrude from the plurality of battery cells and a direction in which the plurality of battery cells are stacked.

In one embodiment, the cell tab accommodating portion may be coupled with the cell tabs by moving in a direction parallel to a direction in which the cell tabs protrude from the plurality of battery cells.

In one embodiment, the assembly guide may move in the height direction as the bus bar assembly contacts the base portion.

In one embodiment, the assembly guide may further include an alarm generating portion generating an alarm when the load measured by the load cell is equal to or greater than a preset value.

In one embodiment, the cell tab accommodating portion may include: a first accommodating portion coupled with first cell tabs protruding from the plurality of battery cells in a first direction; and a second accommodating portion coupled with second cell tabs protruding from the plurality of battery cells in a second direction opposite to the first direction.

In one embodiment, the base portion may include: a first plate contacted by a first bus bar assembly coupled with the first cell tabs contacts; and a second plate contacted by a second bus bar assembly coupled with the second cell tabs contacts.

In one embodiment, the assembly guide may further include a connecting portion connecting the first plate and the second plate to each other.

A battery module manufacturing method according to an embodiment of the present disclosure may include: coupling a cell tab accommodating portion formed at one end of a base portion included in an assembly guide, with cell tabs of a battery cell array in which a plurality of battery cells are stacked; contacting a bus bar assembly and the base portion, as the bus bar assembly, electrically connecting the cell tabs in a height direction perpendicular to both a direction in which the cell tabs protrude from the plurality of battery cells and a direction in which the plurality of battery cells are stacked, is coupled to the cell tabs; and measuring a load applied to the assembly guide by a load cell disposed on the base portion.

In one embodiment, the measuring the load may include measuring the load applied to the assembly guide in the height direction.

In one embodiment, the battery module manufacturing method may further include manufacturing the battery cell array before the coupling the cell tab accommodating portion with the cell tabs.

In one embodiment, the manufacturing the battery cell array may include: forming a sub-battery cell array by stacking two or more battery cells; inspecting alignment of battery cells included in the sub-battery cell array; and stacking a plurality of sub-battery cell arrays.

In one embodiment, the inspecting alignment of battery cells included in the sub-battery cell array may be performed by measuring displacement of the battery cells included in the sub-battery cell array.

In one embodiment, the displacement of the battery cells may be measured using a Linear Variable Differential Transformer (LVDT) sensor.

In one embodiment, in the coupling the cell tab accommodating portion with the cell tabs, the assembly guide may move in a direction parallel to a direction in which the cell tabs protrude from the plurality of battery cells.

In one embodiment, the assembly guide may move in the height direction, as the bus bar assembly contacts the base portion.

In one embodiment, as coupling of the bus bar assembly with the cell tabs is completed, the assembly guide may be removed from the cell tabs.

In one embodiment, the battery module manufacturing method may further include generating an alarm when a load measured by the load cell is equal to or greater than a preset value.

In one embodiment, a load measured by the load cell may change depending on the degree of alignment of the plurality of battery cells.

According to the present disclosure, an assembly guide and a battery module manufacturing method that can minimize damage or deformation of battery cells and cell tabs included therein and at the same time, easily perform coupling of cell tabs and a bus bar assembly can be provided.

### BRIEF DESCRIPTION OF THE DRAWINGS

FIG. 1 is a diagram for explaining configurations used in manufacturing a battery module according to one embodiment of the present invention.

FIG. 2 is a diagram for explaining an assembly guide according to one embodiment of the present invention.

FIG. 3 is a diagram for explaining a bus bar assembly used in manufacturing a battery module according to one embodiment of the present invention.

FIGS. 4 to 7 are diagrams for explaining an assembly process of a bus bar assembly according to one embodiment of the present invention.

FIG. 8 is a diagram for explaining an assembly guide according to another embodiment of the present invention.

FIG. 9 is a flowchart for explaining a battery module manufacturing method according to one embodiment of the present invention.

FIG. 10 is a diagram for explaining a battery cell array manufacturing process in manufacturing a battery module according to one embodiment of the present invention.

FIG. 11 is a diagram for explaining Step S10 of FIG. 10 in more detail.

FIG. 12 is a diagram for explaining Step S20 of FIG. 10 in more detail.

FIG. 13 is a diagram for explaining Step S30 of FIG. 10 in more detail.

### DETAILED DESCRIPTION

The structural or functional descriptions of embodiments disclosed in the present specification or application are merely illustrated for the purpose of explaining embodiments according to the technical principle of the present invention, and embodiments according to the technical principle of the present invention may be implemented in various forms in addition to the embodiments disclosed in the specification of application. In addition, the technical principle of the present invention is not construed as being limited to the embodiments described in the present specification or application.

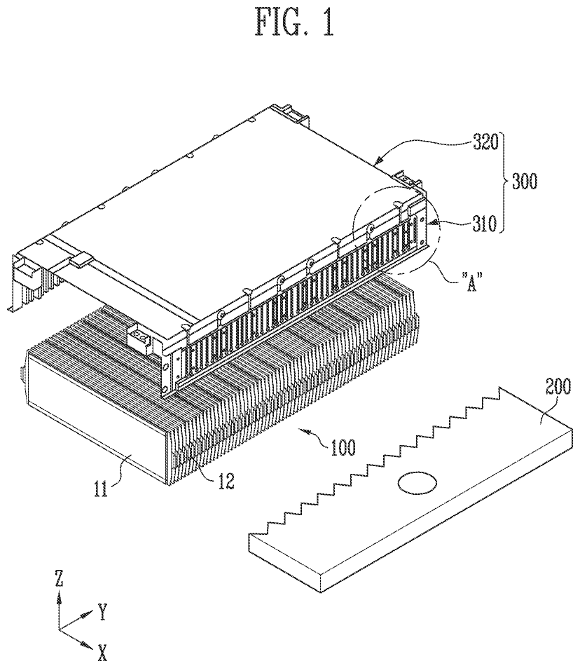

FIG. 1 is a diagram for explaining configurations used in manufacturing a battery module according to one embodiment of the present invention.

Referring to FIG. 1, a battery module may be manufactured by coupling a bus bar assembly 300 with a battery cell array 100. A battery cell array 100 may include a plurality of battery cells 11.

In an embodiment, each battery cell 11 may include a cathode, an anode, and a separator disposed therebetween.

In an embodiment, a cathode and an anode may each include a current collector and an active material layer disposed on a current collector. For example, a cathode may include a cathode current collector and a cathode active material layer, and an anode may include an anode current collector and an anode active material layer.

A current collector may include a known conductive material to an extent that it does not cause a chemical reaction within a lithium secondary battery.

An active material layer may include an active material, and for example, a cathode active material layer may include a cathode active material, and an anode active material layer may include an anode active material. A cathode active material is a material which lithium (Li) ions may be inserted into and extracted from, and an anode active material is a material which lithium ions may be adsorbed into and extracted from.

In addition, a cathode and an anode may each further include a binder and a conductive material. A binder may improve mechanical stability by mediating a bond between a current collector and an active material layer, and a conductive material may improve electrical conductivity of a lithium secondary battery.

A separator may be disposed between a cathode and an anode. A separator may be configured to prevent electrical short-circuiting between a cathode and an anode and to generate a flow of ions.

According to an embodiment, a separator may include a porous polymer film or a porous non-woven fabric.

Each of battery cells 11 may include cell tabs 12 protruding from battery cells 11. In the present specification, a direction in which cell tabs 12 protrude from battery cells 11 may be defined as the X-axis direction. Cell tabs 12 illustrated in FIG. 1 are illustrated to protrude from battery cells 110 in both directions of the X-axis, but they are not limited thereto, and cell tabs 12 may protrude only in any one direction of the X-axis.

A battery cell array 100 may consist of a plurality of battery cells 11 stacked on each other. In the present specification, a direction in which battery cells 11 are stacked may be defined as the Y-axis direction.

An assembly guide 200 may be used to smoothly couple a bus bar assembly 300 with a battery cell array 100. Before a bus bar assembly 300 is coupled with cell tabs 12, an assembly guide 200 may first be coupled with the cell tabs 12.

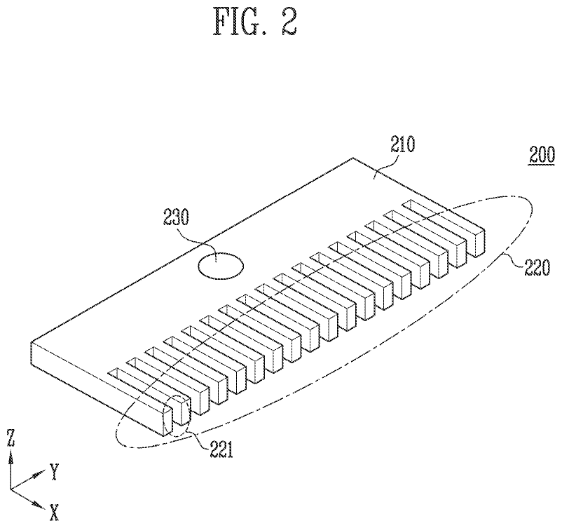

An assembly guide 200 may include a plurality of grooves in which cell tabs 12 may each be accommodated. An assembly guide 200 will be described in more detail in FIG. 2 below.

A bus bar assembly 300 may be coupled with cell tabs 12 in a direction perpendicular to a direction in which the cell tabs 12 protrude from battery cells 11, that is, in a direction perpendicular to the X-axis direction. In the present specification, a direction in which a bus bar assembly 300 is coupled with cell tabs 12 may be defined as the Z-axis direction. The X-axis direction, Y-axis direction, and Z-axis direction defined in the present specification may be orthogonal to each other.

In FIG. 1, since cell tabs 12 protrude from battery cells 11 in both directions of the X-axis, a bus bar assembly 300 may be coupled with all cell tabs 12 to be positioned in both directions of the X-axis of a battery cell array 100. However, in another embodiment, in the case where cell tabs 12 protrude from battery cells 11 in only any one direction of the X-axis, a bus bar assembly 300 may be coupled with cell tabs 12 to be positioned in only any one direction of the X-axis of a battery cell array 100.

A busbar assembly 300 may include a coupling portion 310 coupled with cell tabs 12. In one embodiment, as shown in FIG. 1, in the case where cell tabs 12 protrude from battery cells 11 in both directions of the X-axis, a bus bar assembly 300 may include two coupling portions 310 to be coupled with all cell tabs 12 in both directions.

In another embodiment, in the case where cell tabs 12 protrude from battery cells 11 in only any one direction of the X-axis, a bus bar assembly 300 may include one coupling portion 310 to be coupled with cell tabs 12 in one direction.

In one embodiment, as shown in FIG. 1, a bus bar assembly 300 may include an upper cover 320 for connecting the two coupling portions 310 to each other. However, in another embodiment, a bus bar assembly 300 may consist of only two separate coupling portions 310 without a separate upper cover 320.

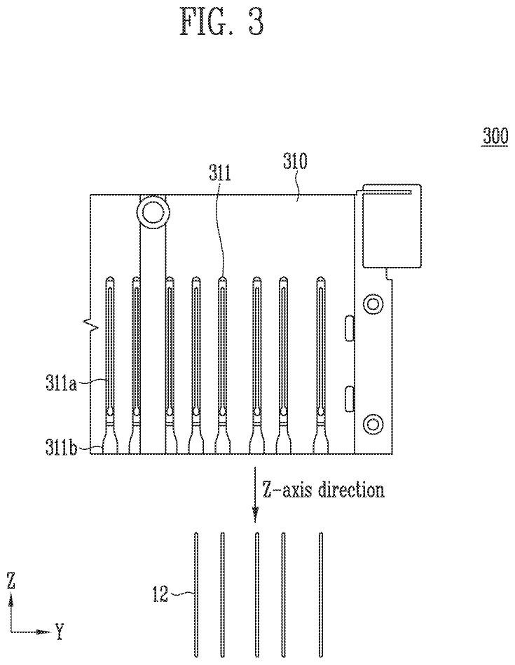

A coupling portion 310 included in a bus bar assembly 300 may include a plurality of opening portions in which cell tabs 12 may each be accommodated. A bus bar assembly 300 will be described in more detail in FIG. 3 below.

FIG. 2 is a diagram for explaining an assembly guide according to one embodiment of the present invention.

Referring to FIG. 2, an assembly guide 200 may include a base portion 210.

When a bus bar assembly is coupled with cell tabs 120 after an assembly guide 200 is coupled with the cell tabs 120, a bus bar assembly may contact a base portion 210. As a bus bar assembly and a base portion 210 contact each other, the bus bar assembly may push out an assembly guide 200 in the Z-axis direction.

In addition, an assembly guide 200 may include a cell tab accommodating portion 220 formed at one end of a base portion 210.

A cell tab accommodating portion 220 may include a plurality of grooves 221. A plurality of grooves 221 may be formed to face cell tabs, and in one embodiment, grooves 221 may have a concave shape to face each of cell tabs protruding from battery cells. In other words, grooves 221 may have a concave shape in the X-axis direction. For example, a groove 221 may be concave to have a triangular cross-section as illustrated in FIG. 1, or may be concave to have a rectangular cross-section as illustrated in FIG. 2. In another embodiment, a groove 220 may be concave to have a curved cross-section.

One or more cell tabs may be accommodated in each of grooves 221. More specifically, a single call tab may be accommodated in each of grooves 221.

Grooves 221 may be formed to be spaced apart from each other in a predetermined spacing. In an embodiment, a predetermined spacing may be determined according to a spacing between cell taps. For example, a spacing between grooves 221 may be set so that a single cell tab may be inserted into a single groove 221.

In an embodiment, at least one end of grooves 221 in the Z-axis direction may be open. Accordingly, after an assembly guide 200 is coupled with cell tabs in the X-axis direction and the cell tabs are accommodated in each groove 221, the assembly guide 200 may be movable in the Z-axis direction. More specifically, after cell tabs are accommodated in each groove 221, while a bus bar assembly is coupled with the cell tabs in the Z-axis direction, the bus bar assembly pushes out an assembly guide 200 in the Z-axis direction so that the assembly guide 200 may move in the Z-axis direction.

In addition, an assembly guide 200 may include a load cell 230 formed on a base portion 210.

A load cell 230 may measure a load in the Z-axis direction applied to the assembly guide 200.

A load in the Z-axis direction measured by a load cell 230 may be determined by a force applied to an assembly guide 200 by a busbar assembly and a force applied to an assembly guide 200 by cell tabs 12.

For example, when battery cells of a battery cell array are ideally aligned, as a bus bar assembly is coupled with the cell tabs, the bus bar assembly pushes an assembly guide 200 in the Z-axis direction, and the assembly guide 200 moves relatively smoothly in the Z-axis direction. That is, in this case, a load in the Z-axis direction measured by a load cell 230 may be relatively small.

On the other hand, when battery cells of a battery cell array are not ideally aligned, and some battery cells protrude in the X-axis direction, even if a bus bar assembly pushes out an assembly guide 200 in the Z-axis direction, movement in the Z-axis direction may not be smooth because the assembly guide may be caught by protruding battery cells or cell tabs of the battery cells. That is, in this case, a load in the Z-axis direction measured by a load cell 230 may be relatively large.

In one embodiment, a load in the Z-axis direction measured by a load cell 230 may vary depending on the number of unaligned cell tabs, a protruding length of the unaligned cell tabs or the like.

Accordingly, a load cell 230 may confirm whether alignment of battery cells is abnormal by measuring a load in the Z-axis direction applied to an assembly guide 200. In an embodiment, when abnormal alignment of battery cells is confirmed, damage to the battery cells may be prevented by discontinuing assembly of a bus bar assembly.

FIG. 3 is a diagram for explaining a bus bar assembly used in manufacturing a battery module according to one embodiment of the present invention.

As illustrated in FIG. 1, a bus bar assembly 300 may include a coupling portion 310, and FIG. 3 shows an enlarged diagram of portion A of a coupling portion 310 shown in FIG. 1.

Referring to FIG. 3, a coupling portion 310 may include a plurality of opening portions 311 in which cell tabs 12 may each be accommodated.

Opening portions 311 may be formed in the shape of long holes with a predetermined length along the Z-axis direction so that cell tabs 120 may be accommodated therein.

In an embodiment, one end of opening portions 311 in the Z-axis direction may be open. As one end of opening portions 311 in the Z-axis direction is opened, cell tabs 120 may be inserted into the opening portions 311 in the Z-axis direction.

As such, one open end of an opening portion 311 may be an insertion portion 311b. An insertion portion 311b may be a part where a cell tab 120 first enters into an opening portion 311.

In addition, the other end of opening portions 311 in the Z-axis direction may be closed. In this way, the other closed end of an opening portion 311 may be a fixing portion 311a. A fixing portion 311a may be a part where a cell tab 120 that enters into an opening portion 311 is fixed.

In one embodiment, the width of insertion portions 311b may be larger than the width of fixing portions 311a so that cell tabs 120 may easily enter into opening portions 311.

As a bus bar assembly 300 moves toward cell tabs 120 in the Z-axis direction, the cell tabs 120 enter into opening portions through insertion portions 311b of each of the opening portions 311, and as the cell tabs 120 are fixed to fixing portions 311a, a bus bar assembly 300 and cell tabs 120 may be coupled.

Opening portions 311 may be formed to be spaced apart from each other in a predetermined spacing. In an embodiment, a predetermined spacing may be determined according to a spacing between cell taps. For example, a spacing between grooves 220 may be set so that a single cell tab may be inserted into a single opening portion 311.

In an embodiment, a spacing between opening portions 311 may correspond to a spacing between grooves of an assembly guide. For example, a spacing between openings portions 311 may be the same as a spacing between grooves of the assembly guide, and accordingly, cell tabs 120 aligned by the assembly guide may be easily inserted into the opening portions 311.

In addition, when coupling a bus bar assembly 300 with cell tabs 120, the cell tabs 120 aligned by the assembly guide may each be positioned within the width of an insertion portion 311b of an opening portion 311. Therefore, even when there is a slight mismatch between the positions of cell tabs 120 aligned by the assembly guide and fixing portions 311a of opening portions 311, due to the presence of insertion portions 311b having a relatively wide width, call tabs 120 may be inserted into fixing portions 311a included in opening portions 311.

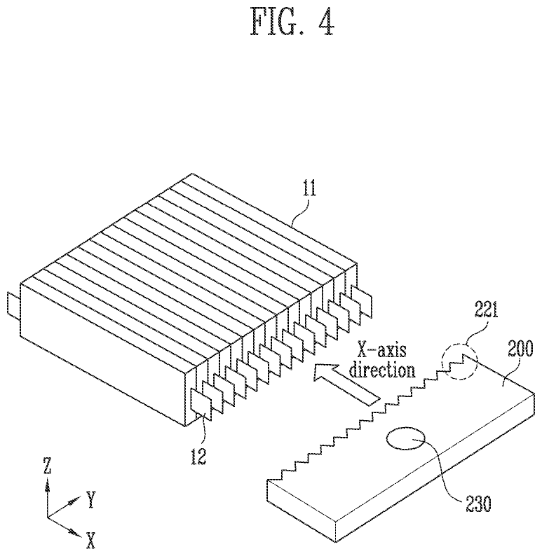

FIGS. 4 to 7 are diagrams for explaining an assembly process of a bus bar assembly according to one embodiment of the present invention.

Referring to FIG. 4, an assembly guide 200 may be coupled with cell tabs 12 of battery cells 11. In one embodiment, as illustrated in FIG. 4, an assembly guide 200 may be coupled with cell tabs 12 in the X-axis direction, but a coupling direction of an assembly guide 200 and cell tabs 12 is not limited to a specific direction.

As an assembly guide 200 is coupled with cell tabs 12 of battery cells 110, the cell tabs 12 may each be accommodated in grooves 221 of the assembly guide 200.

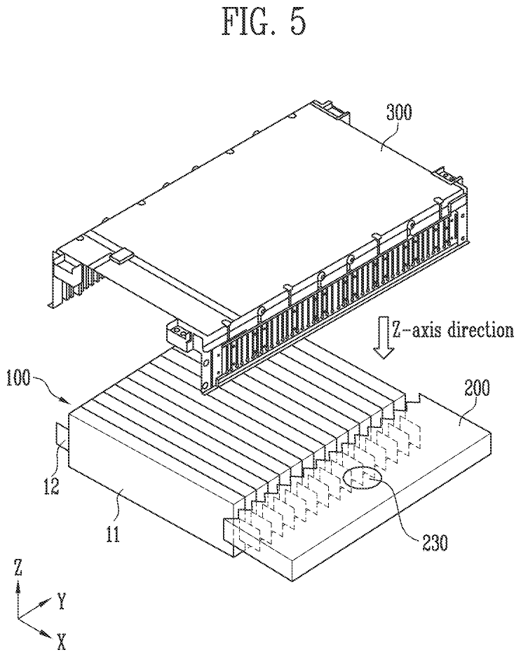

Referring to FIG. 5, in a state where an assembly guide 200 is coupled with cell tabs 12, a busbar assembly 300 may be coupled with the cell tabs 12. In an embodiment, a busbar assembly 300 may be coupled with cell tabs 12 in the Z-axis direction.

More specifically, when a bus bar assembly 300 may move toward cell tabs 12 in the Z-axis direction, cell tabs 120 aligned by an assembly guide 200 may be inserted into opening portions of the bus bar assembly 300.

As a bus bar assembly 300 is coupled with cell tabs 12 in the Z-axis direction, the bus bar assembly 300 and an assembly guide 200 may contact each other. More specifically, one cross-section of a bus bar assembly 300 in the Z-axis direction and one cross-section of a base portion included in an assembly guide 200 in the Z-axis direction may contact each other.

As a bus bar assembly 300 and a base portion of an assembly guide 200 contact each other, the bus bar assembly 300 may push out the assembly guide 200 in the Z-axis direction. More specifically, an assembly guide 200 may receive a force in the Z-axis direction by a bus bar assembly 300 and move in the Z-axis direction by the force in the Z-axis direction.

At this time, a load cell 230 included in an assembly guide 200 may measure a load applied to the assembly guide 200 in the Z-axis direction.

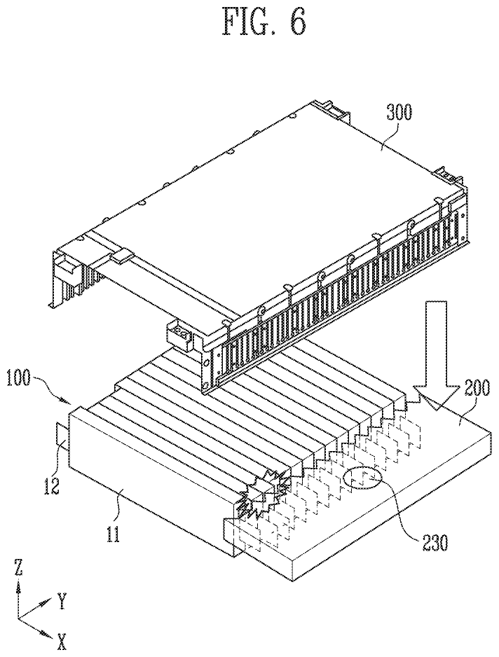

Referring to FIG. 6, in one embodiment, some battery cells of a battery cell array 100 may not be aligned and may protrude in one direction. When a bus bar assembly 300 is coupled with cell tabs 12 in the Z-axis direction, a force is applied to an assembly guide 200 in the Z-axis direction by the bus bar assembly 300, and at the same time, a force is also applied in the opposite direction by protruding battery cells.

Accordingly, a load applied to an assembly guide 200 in the Z-axis direction measured by a load cell 230 may have a value greater than a preset value. When a load applied to an assembly guide 200 in the Z-axis direction is greater than a preset value, an alarm may be generated by an alarm generating portion included in the assembly guide 200. In one embodiment, an alarm may be generated visually in connection with a display, or it may be generated audibly in connection with an audio device.

An alarm indicating that a load applied to an assembly guide 200 in the Z-axis direction is greater than a preset value may mean an alignment abnormality of battery cells. That is, it may be known by an alarm that battery cells are not preferably aligned and that some battery cells are protruding. Accordingly, damage to battery cells may be prevented by discontinuing assembly of a bus bar assembly 300.

In one embodiment, after battery cells are realigned by adjusting the positions of the battery cells, coupling of a busbar assembly 300 may be resumed.

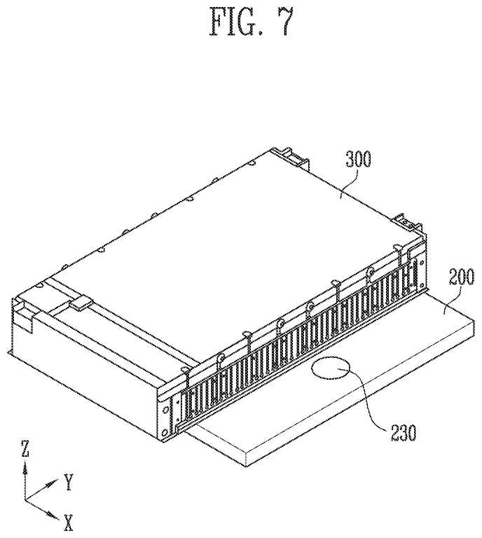

Referring to FIG. 7, all battery cells of the battery cell array 100 may be preferably aligned. In the present specification, battery cells being preferably aligned may mean that the position difference of battery cells in the X-axis direction is within an error range.

In this case, as shown in FIG. 5, as a bus bar assembly 300 is coupled with cell tabs in the Z-axis direction, an assembly guide 200 may be pushed out in the Z-axis direction.

When coupling of a bus bar assembly 300 to cell tabs is completed, that is, when cell tabs 12 are fixed by being positioned on a fixing portion of a bus bar assembly 300, the assembly guide 200 may be removed from the cell tabs 120.

Therefore, an assembly guide 200 is only used during a manufacturing process of a battery module, and an assembly guide 200 may not be included in a finally manufactured battery module.

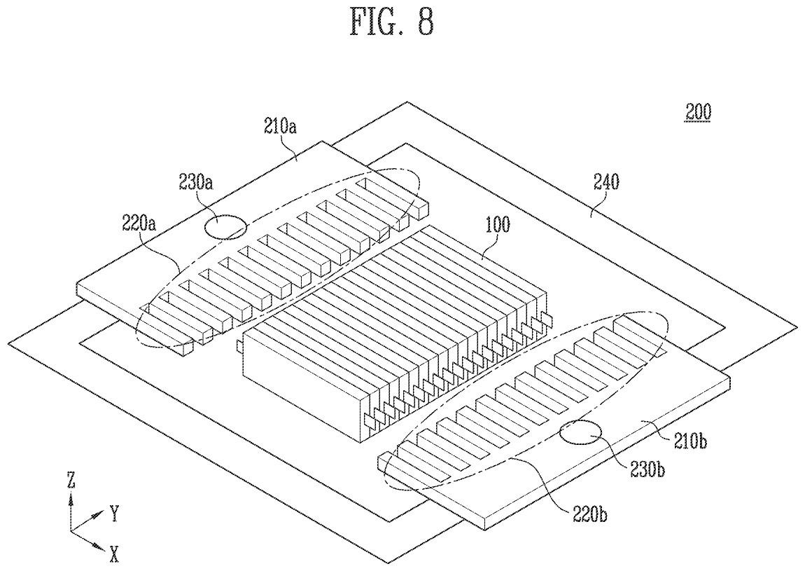

FIG. 8 is a diagram for explaining an assembly guide according to another embodiment of the present invention.

Referring to FIG. 8, cell tabs of a battery cell array 100 may protrude in both directions (first direction, second direction) of the X-axis.

In an embodiment, an assembly guide 200 may include a first accommodating portion 220a coupled with cell tabs protruding in a first direction and a second accommodating portion 220b coupled with cell tabs protruding in a second direction. In an embodiment, a first accommodating portion 220a and a second accommodating portion 220b may constitute a cell tab accommodating portion.

In an embodiment, a bus bar assembly may be divided into a first coupling portion coupled with cell tabs protruding in a first direction and a second coupling portion coupled with cell tabs protruding in a second direction. In one embodiment, as illustrated in FIG. 1, a bus bar assembly may include an upper cover for connecting a first coupling portion and a second coupling portion each other. However, in another embodiment, a bus bar assembly may be configured with only two separated coupling portions (a first coupling portion and a second coupling portion) without a separate upper cover.

An assembly guide 200 may include a first plate 210a contacting a first bus bar assembly and a second plate 210b contacting a second bus bar assembly. A first plate 210a may be connected to a first accommodating portion 220a, and a second plate 210b may be connected to the second accommodating portion 220b. In one embodiment, a first plate 210a and a second plate 210b may constitute a base portion.

A first load cell 230a and a second load cell 230b may be disposed on a first plate 210a and a second plate 210b, respectively. A first load cell 230a and a second load cell 230b may measure a load applied to a first plate 210a and a load applied to a second plate 210b, respectively.

An assembly guide 200 may include a connecting portion 240 connecting a first plate 210a and a second plate 210b. In one embodiment, a connection portion 240 may further include a moving means for moving a first plate 210a and a second plate 210b in the X-axis direction. As a first plate 210a and a second plate 210b are moved in the X-axis direction by a moving means, a first accommodating portion 220a and a second accommodating portion 220b may be coupled with cell tabs.

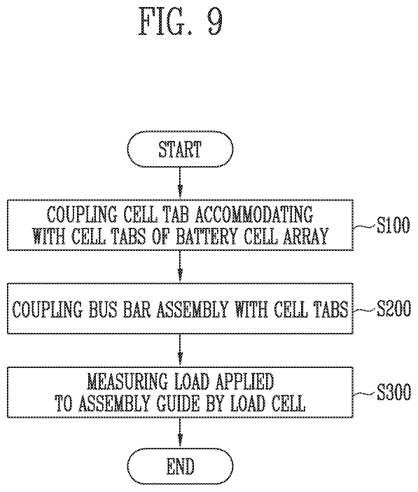

FIG. 9 is a flowchart for explaining a battery module manufacturing method according to one embodiment of the present invention.

Referring to FIG. 9, an assembly guide may be coupled with cell tabs of a battery cell array in Step S100. More specifically, a cell tab accommodating portion included in an assembly guide may be coupled with cell tabs, and a cell tab accommodating portion may be formed at one end of a base portion included in an assembly guide.

An assembly guide may align cell tabs of each of a plurality of battery cells. That is, by aligning cell tabs, an assembly guide may guide cell tabs so that the cell tabs may be easily coupled with a busbar assembly in a later step.

In one embodiment, an assembly guide may be coupled with cell tabs in the X-axis direction.

In another embodiment, an assembly guide may be coupled with cell tabs in the Z-axis direction.

In still another embodiment, an assembly guide may be coupled with cell tabs to form an angle θ with an XY plane, wherein the θ may be 0°<θ<90°.

In other words, an angle at which an assembly guide is coupled with cell tabs may be set in various ways depending on the shape of the assembly guide, and is not limited to a specific angle. However, after coupling, the assembly guide may be coupled with cell tabs so that it may move in a direction perpendicular to a direction in which the cell tabs protrude.

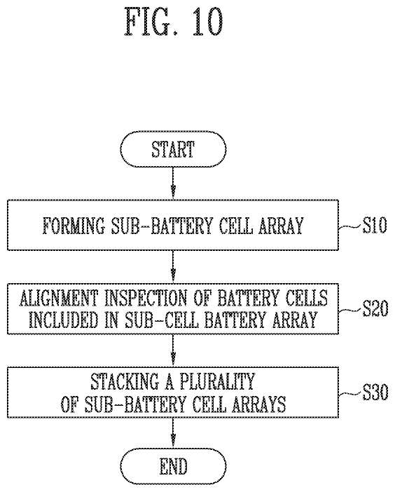

In an embodiment, a battery cell array may be a stack of a plurality of battery cells. Manufacturing a battery cell array may be performed before Step S100. Manufacturing a battery cell array will be described in more detail in FIGS. 10 to 13 below.

In an embodiment, a cell tab accommodating portion may include a plurality of grooves formed to face cell tabs.

Next, in Step S200, a busbar assembly may be coupled with cell tabs. More specifically, a busbar assembly may be coupled with cell tabs in the Z-axis direction.

In an embodiment, a busbar assembly may electrically connect cell tabs each other.

In an embodiment, as a busbar assembly is coupled with cell tabs in the Z-axis direction, the busbar assembly may contact an assembly guide coupled with cell tabs. That is, a bus bar assembly may apply a force to an assembly guide in the Z-axis direction.

In one embodiment, a bus bar assembly may contact the assembly guide in a process of coupling with cell tabs, and while contacting the assembly guide, a bus bar assembly may push out the assembly guide in a direction in which cell tabs protrude from battery cells. Here, the meaning of contacting may include not only cases where a bus bar assembly and an assembly guide are in a direct contact, but also cases where additional features exist between a bus bar assembly and the assembly guide.

Next, in Step S300, a load cell may measure a load applied to an assembly guide. In an embodiment, a load cell may be disposed on a base portion, and a load cell may measure a load applied to an assembly guide in the Z-axis direction.

Based on a load measured by a load cell, abnormal alignment of battery cells may be determined. In one embodiment, when a load measured by a load cell is equal to or more than a preset value, it may be determined that battery cells are misaligned. When a load measured by a load cell is less than a preset value, it may be determined that battery cells are preferably aligned. A load measured by a load cell may vary depending on the degree of alignment of battery cells.

In one embodiment, providing an alarm when it is determined that battery cells are misaligned may be further included.

When an alarm is provided, coupling of a busbar assembly may be discontinued.

In another embodiment, when it is determined that battery cells are preferably aligned, a busbar assembly may continue to be coupled with cell tabs in the Z-axis direction.

As a bus bar assembly is coupled with cell tabs in the Z-axis direction and thus a force in the Z-axis direction is applied to an assembly guide, the assembly guide moves in the Z-axis direction. Once coupling of a busbar assembly to cell tabs is completed, the assembly guide may finally be removed from the cell tabs.

In an embodiment, after a busbar assembly and cell tabs are coupled, welding a busbar assembly and cell tabs may be further included.

FIG. 10 is a diagram for explaining a battery cell array manufacturing process when manufacturing a battery module according to one embodiment of the present invention.

FIG. 10 shows steps performed before Step S100 of FIG. 9.

Referring to FIG. 10, a sub-battery cell array may be formed in Step S10. A sub-battery cell array may be formed by stacking two or more battery cells. A sub-battery cell array may include a smaller number of battery cells than a battery cell array in Step S100 of FIG. 9.

In Step S20, alignment of battery cells included in a sub-battery cell array may be inspected. Alignment inspection of battery cells included in a sub-battery cell array may be performed by measuring the displacement of battery cells included in a sub-battery cell array. In one embodiment, the displacement of battery cells included in a sub-battery cell array may be measured using a Liner Variable Differential Transformer (LVDT) sensor.

In Step S30, a plurality of sub-battery cell arrays may be stacked. By stacking a plurality of sub-battery cell arrays, a battery cell array in Step S100 of FIG. 9 may be formed. In Step S30, alignment of sub-battery cell arrays may also be inspected. Alignment inspection of sub-battery cell arrays may also be performed by measuring the displacement of each sub-battery cell array, for example, using a Liner Variable Differential Transformer (LVDT) sensor.

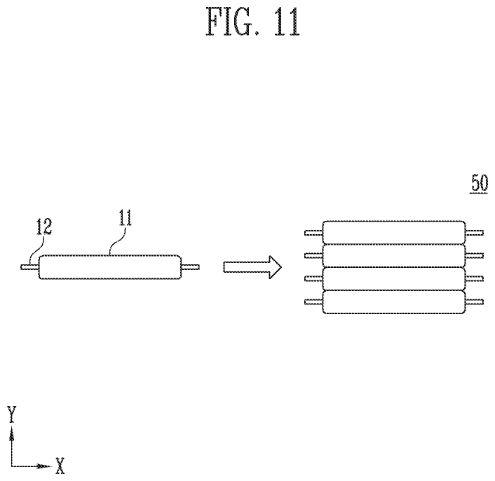

FIG. 11 is a diagram for explaining Step S10 of FIG. 10 in more detail.

Referring to FIG. 11, a plurality of battery cells 11 may be stacked to form a sub-battery cell array 50. Cell tabs 12 may protrude in the X-axis direction of battery cells 11, and battery cells 11 may be stacked in the Y-axis direction.

In FIG. 11, it is illustrated that four battery cells 11 are stacked to form a sub-battery cell array 50. However, a sufficient number of battery cells 11 included in a sub-battery cell array 50 is two or more, and it is not limited to four.

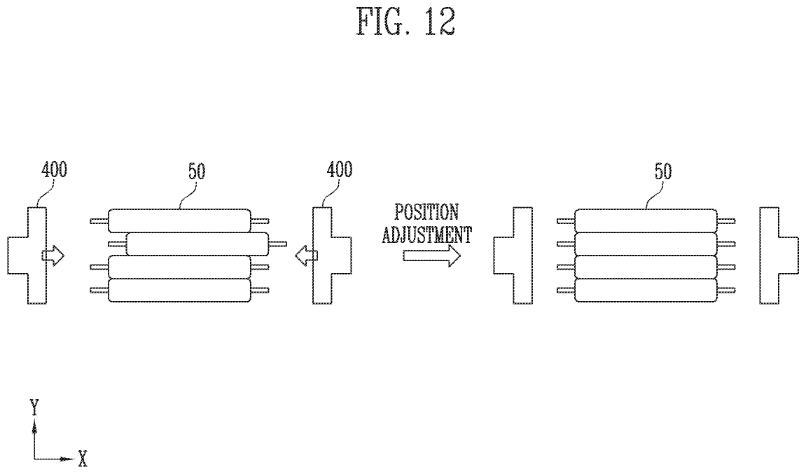

FIG. 12 is a diagram for explaining Step S20 of FIG. 10 in more detail.

Referring to FIG. 12, alignment of battery cells included in a sub-battery cell array 50 may be inspected. Alignment inspection of battery cells included in a sub-battery cell array 50 may be performed by measuring the displacement of battery cells included in a sub-battery cell array 50. More specifically, alignment inspection of battery cells included in a sub-battery cell array 50 may be performed by measuring the displacement of battery cells in the X-axis direction.

In one embodiment, the displacement of battery cells included in a sub-battery cell array 50 may be measured using a displacement measuring means 400 such as a Liner Variable Differential Transformer (LVDT) sensor.

As shown in the left diagram of FIG. 12, when it is determined by a displacement measuring means 400 that some of battery cells included in a sub-battery cell array 50 are misaligned, as shown in the right diagram of FIG. 12, the positions of the battery cells may be adjusted so that the battery cells included in the sub-battery cell array 50 may be aligned in the Y-axis direction. For example, the positions of battery cells included in a sub-battery cell array 50 in the X-axis direction may be adjusted.

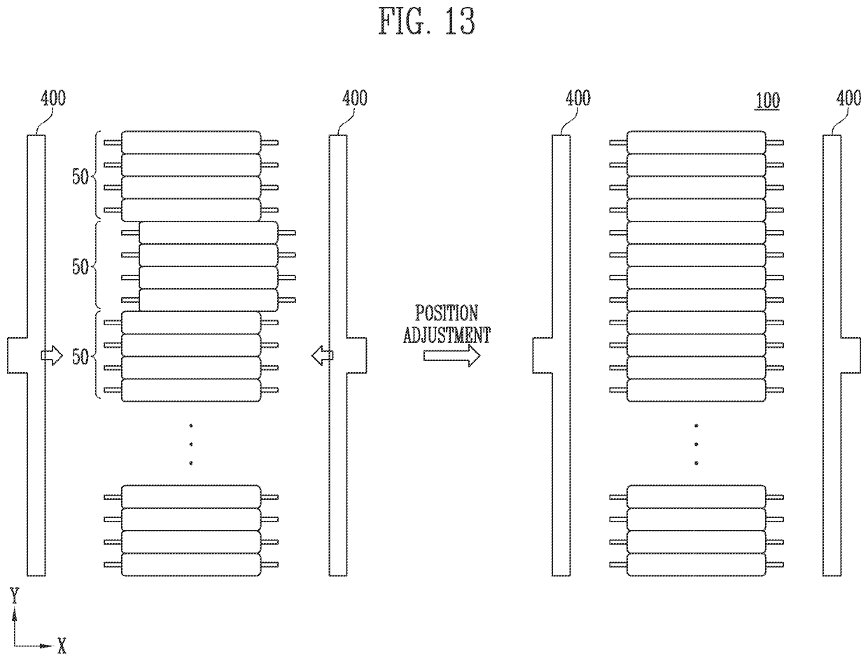

FIG. 13 is a diagram for explaining Step S30 of FIG. 10 in more detail.

Referring to FIG. 13, a plurality of sub-battery cell arrays 50 may be stacked. Each of a plurality of sub-battery cell arrays 50 may be formed according to a process illustrated in FIGS. 11 and 12. Therefore, battery cells included in each of sub-battery cell arrays 50 may be aligned in the Y-axis direction.

However, as shown in the left diagram of FIG. 13, some sub-battery cell arrays 50 among a plurality of sub-battery cell arrays 50 may be entirely misaligned in the Y-axis direction, and accordingly, alignment of the sub-battery cell arrays 50 may be inspected.

Alignment inspection of sub-battery cell arrays 50 may be performed by measuring the displacement of each of sub-battery cell arrays 50. More specifically, alignment inspection of sub-battery cell arrays 50 may be performed by measuring the displacement of sub-battery cell arrays 50 in the X-axis direction.

In one embodiment, the displacement of sub-battery cell arrays 50 may be measured using a displacement measuring means 400 such as a Liner Variable Differential Transformer (LVDT) sensor.

As shown in the left diagram of FIG. 13, when it is determined by a displacement measuring means 400 that some of sub-battery cell arrays 50 are misaligned, as shown in the right diagram of FIG. 13, the positions of sub-battery cell arrays 50 may be adjusted so that the sub-battery cell arrays 50 may be aligned in the Y-axis direction. For example, the positions of sub-battery cell arrays 50 in the X-axis direction may be adjusted.

As described above, a battery cell array 100 in Step S100 of FIG. 9 may be manufactured through the processes of FIGS. 11 to 13.

What is claimed is:

1. An assembly guide, which is used to align cell tabs to couple a bus bar assembly with the cell tabs protruding from a plurality of battery cells stacked, the assembly guide comprising:
a base portion contacting the bus bar assembly as the bus bar assembly is coupled with the cell tabs;
a cell tab accommodating portion including a plurality of grooves formed at one end of the base portion to face the cell tabs; and
a load cell disposed on the base portion to measure a load applied to the assembly guide.

2. The assembly guide according to claim 1, wherein the load cell measures a load applied to the assembly guide in a height direction perpendicular to both a direction in which the cell tabs protrude from the plurality of battery cells and a direction in which the plurality of battery cells are stacked.

3. The assembly guide according to claim 2, wherein the cell tab accommodating portion is coupled with the cell tabs by moving in a direction parallel to a direction in which the cell tabs protrude from the plurality of battery cells.

4. The assembly guide according to claim 2, wherein the assembly guide moves in the height direction as the bus bar assembly contacts the base portion.

5. The assembly guide according to claim 1, wherein the assembly guide further comprises an alarm generating portion generating an alarm when the load measured by the load cell is equal to or greater than a preset value.

6. The assembly guide according to claim 1, wherein the cell tab accommodating portion includes:
a first accommodating portion coupled with first cell tabs protruding from the plurality of battery cells in a first direction; and
a second accommodating portion coupled to second cell tabs protruding from the plurality of battery cells in a second direction opposite to the first direction.

7. The assembly guide according to claim 6, wherein the base portion includes:
a first plate contacted by a first bus bar assembly coupled with the first cell tabs contacts; and
a second plate contacted by a second bus bar assembly coupled with the second cell tabs contacts.

8. The assembly guide according to claim 7, wherein the assembly guide further includes a connecting portion connecting the first plate and the second plate to each other.

9. A battery module manufacturing method comprising:
coupling a cell tab accommodating portion formed at one end of a base portion included in an assembly guide, with cell tabs of a battery cell array in which a plurality of battery cells are stacked;
contacting a bus bar assembly and the base portion, as the bus bar assembly, electrically connecting the cell tabs in a height direction perpendicular to both a direction in which the cell tabs protrude from the plurality of battery cells and a direction in which the plurality of battery cells are stacked, is coupled to the cell tabs; and
measuring a load applied to the assembly guide by a load cell disposed on the base portion.

10. The battery module manufacturing method according to claim 9, wherein the measuring the load includes measuring the load applied to the assembly guide in the height direction.

11. The battery module manufacturing method according to claim 9, the battery module manufacturing method further comprising:
manufacturing the battery cell array before the coupling the cell tab accommodating portion with the cell tabs.

12. The battery module manufacturing method according to claim 11, wherein the manufacturing the battery cell array includes:
forming a sub-battery cell array by stacking two or more battery cells;
inspecting alignment of battery cells included in the sub-battery cell array; and
stacking a plurality of sub-battery cell arrays.

13. The battery module manufacturing method according to claim 12, wherein the inspecting alignment of the battery cells included in the sub-battery cell array includes measuring displacement of the battery cells included in the sub-battery cell array.

14. The battery module manufacturing method according to claim 13, wherein the displacement of the battery cells is measured using a Linear Variable Differential Transformer (LVDT) sensor.

15. The battery module manufacturing method according to claim 9, wherein, during the coupling the cell tab accommodating portion with the cell tabs, the assembly guide moves in a direction parallel to a direction in which the cell tabs protrude from the plurality of battery cells.

16. The battery module manufacturing method according to claim 9, wherein the assembly guide moves in the height direction, as the bus bar assembly contacts the base portion.

17. The battery module manufacturing method according to claim 16, wherein, as coupling of the bus bar assembly with the cell tabs is completed, the assembly guide is removed from the cell tabs.

18. The battery module manufacturing method according to claim 9, the battery module manufacturing method further comprising:
generating an alarm when a load measured by the load cell is equal to or greater than a preset value.

19. The battery module manufacturing method according to claim 18, wherein the load measured by the load cell changes depending on the degree of alignment of the plurality of battery cells.
